(19) United States
(12) Patent Application Publication
(10) Pub. No.: US 2014/0117657 A1
(43) Pub. Date: May 1, 2014

(54) System for Storing and Displaying Photographs and Mementos

(71) Applicant: ALPHA PRODUCTS, INC., Sarasota, FL (US)

(72) Inventor: Stephanie Nikirk, Sarasota, FL (US)

(73) Assignee: Alpha Products, Inc., Sarasota, FL (US)

(21) Appl. No.: 13/662,972

(22) Filed: Oct. 29, 2012

(51) Int. Cl. B42D 3/10; B42D 1/08

(52) U.S. Cl. CPC B42D 3/10; B42D 1/08
USPC 281/29

(57) ABSTRACT

The present disclosure relates to a system for organizing and displaying photographs and mementos. The system includes a container with an internal storage area for retaining and displaying personal mementos. The container includes a pivotal cover with retaining straps. The retaining straps are adapted to releasably secure a photo book to the cover of the container. In a first configuration, the photo book is secured in a manner that permits user's to open and review the contents of the photo book. In a second configuration, the photo book is secured in a manner that secures the cover of the photo book in a closed configuration.

### TECHNICAL FIELD

This disclosure relates to a system for storing and displaying photographs and mementos. More particularly, the present invention relates to a system whereby a photo book can be coupled to a memento container for display and/or storage.

### BACKGROUND OF THE INVENTION

Photo albums have been in use for many years and there are different styles. One style is the traditional photo albums include a series of rigid pages. Each page includes an adhesive layer and a protective, transparent cover sheet. Photo albums allow users to mount individual photographs upon the pages via the adhesive. Once the photographs are property laid out, the protective sheet is secured over the page.

Another style is the photo books which have dramatically increased in popularity in recent years. Photo books, such as those offered by Snapfish® and Shutterfly®, generally include personal photographs that are imprinted onto the individual pages of the book. Photo books eliminate the need to individually mount physical photographs. Photo books also eliminate the need for rigid adhesive sheets and protective films.

Both the traditional photo albums and the photo books suffer from the drawback that they do not allow personal mementos to be preserved alongside the photographs. Thus, although photographs from a vacation may be saved, all the associated mementos from the vacation (such as maps, tickets, menus, shells and the like) are generally lost.

### SUMMARY OF THE INVENTION

It is, therefore, an object of the present disclosure to provide a system that can store both photographs and physical mementos.

It is also an object of the present disclosure to provide a container for storing and displaying mementos, while at the same time providing a system for securing a photo book to the container.

Yet another object is to provide a photo book and memento container wherein the photo book can be secured to the container in at least two different orientations.

These and other objects are achieved via a system for organizing and displaying photographs and mementos. The system includes a container with an internal storage area for retaining and displaying personal mementos. The container includes a pivotal cover with retaining straps. The retaining straps are adapted to releasably secure a photo book to the cover of the container. In a first configuration, the photo book is secured in a manner that permits user's to open and review the contents of the photo book. In a second configuration, the photo book is secured in a manner that secures the cover of the photo book in a closed configuration.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the system of the present invention.

FIG. 2 is a perspective view of the system and showing the photo book separated from the memento container.

FIG. 3 is a perspective view of the system in the closed configuration.

FIG. 4 is a view of alternative embodiment of the photo book.

FIG. 5 is a perspective view of the system in the partially opened configuration.

FIG. 6 is a side elevational view of the memento container.

FIG. 7 is a detailed view of the magnetic closure.

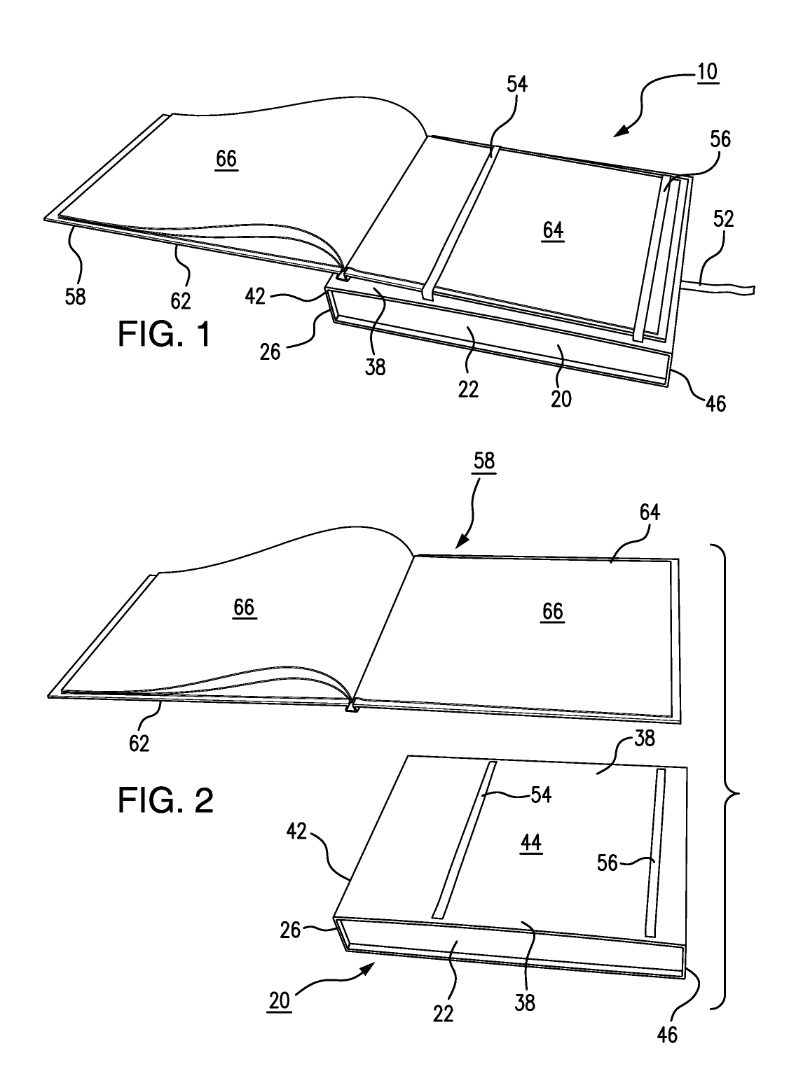

### DETAILED DESCRIPTION OF THE DRAWINGS

The present disclosure relates to a system for organizing and displaying photographs and mementos. The system includes a container with an internal storage area for retaining and displaying personal mementos. The container includes a pivotal cover with retaining straps. The retaining straps are adapted to releasably secure a photo book to the cover of the container. In a first configuration, the photo book is secured in a manner that permits user's to open and review the contents of the photo book. In a second configuration, the photo book is secured in a manner that secures the cover of the photo book in a closed configuration. The details of the present invention, and the manner in which they interrelate, will be described in greater detail hereinafter.

The system 10 includes a container 20. Container 20 is defined by opposing side walls 22 as well and front and rear walls (24 and 26, respectively). The walls (22, 24, and 26) create an internal storage area 28 within the container 20. A plurality of mementos 32 are positioned within storage area 28. Mementos 32 can be, for example, personal keepsakes from vacations or special events. By way of non-limiting example, mementos 32 can comprise articles such as theater tickets, maps, tourist booklets, or other similar souvenirs.

A pair of magnetic closures 36 are positioned within front wall 24 of container 20. A pair of resilient straps 34 are secured within storage area 28 and serve to secure mementos 32 in place. In the preferred embodiment, two cross straps 34 are included. Container 20 includes a cover 38 that is connected to rear wall 26 by way of a hinge 42. Hinge 42 may be a conventional book type hinge or connection. Cover 38 includes an external surface 44 to which the photo book can be secured as noted in more detail hereinafter.

Cover 38 is preferably thick and includes a closure flap 46 at a distal end. More specifically, closure flap 46 is pivotally secured to cover 38 at a location opposite hinge 42. A pair of magnetic closures 48 are positioned within closure flap 46. Closure flap 46 is adapted to be magnetically connected to magnetic closures 36 within front wall 24. This allows cover 38 to be retained in a closed position over storage area 28. A strap 52 is connected to closure flap 46 and functions to assist in releasing the magnetic closures and thereby permit cover 38 to be pivoted to an opened position.

A pair of retaining straps (54 and 56) are secured to the external surface 44 of cover 38. More specifically, an inner strap 54 is secured proximate to hinge 42 and an outer strap 56 is secured adjacent closure flap 46. Each retaining strap (54 and 56) has a first and a second extent. The first extent of each strap extends through the thickness of cover 38. In other words, a length of each strap (54 and 56) is threaded through an opening that extends within cover 38. The second extent of each strap (54 and 56) is then positioned over top of external surface 44 of cover 38. In the preferred embodiment, each strap (54 and 56) is made from an stretchable, elastic material.

System 10 optionally includes a book 58. Book 58 includes a series of internal, flexible pages 66, as well as hard bound front and back covers (62 and 64). A photo or indicia may be imprinted on the front cover 62. Book 58 may be a photo book, such that the individual pages 66 are imprinted with personal photographs. The inner and outer retaining straps (54 and 56) can be selectively secured about back cover 64 of book 58 such that book 58 and container 20 are releasably secured to one another.

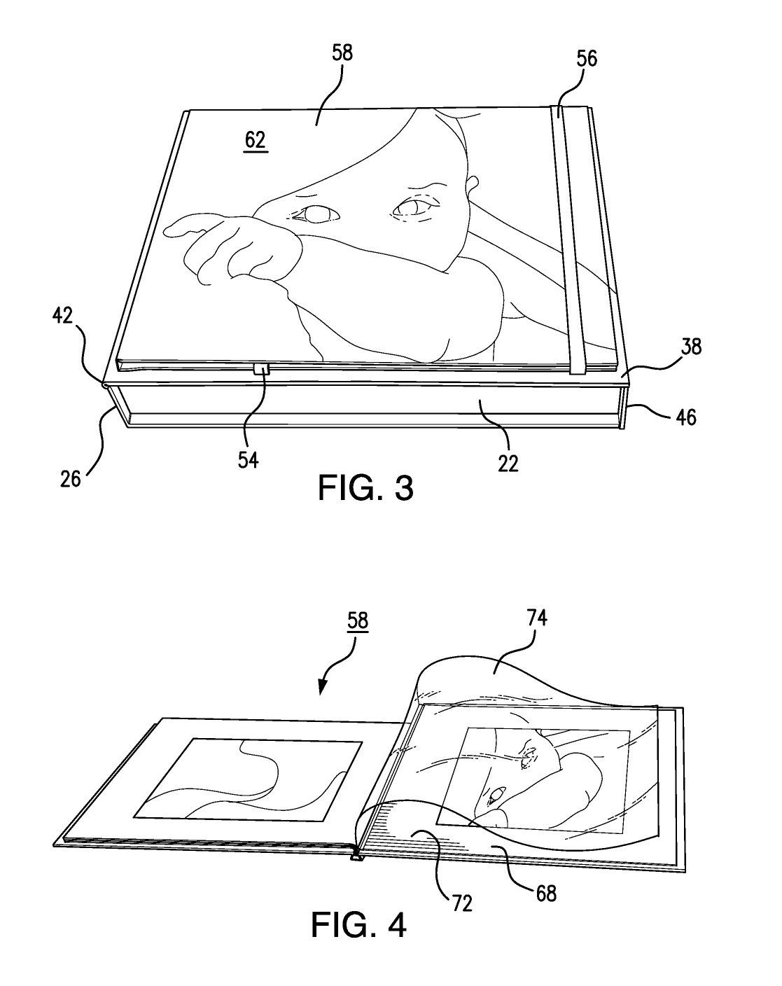

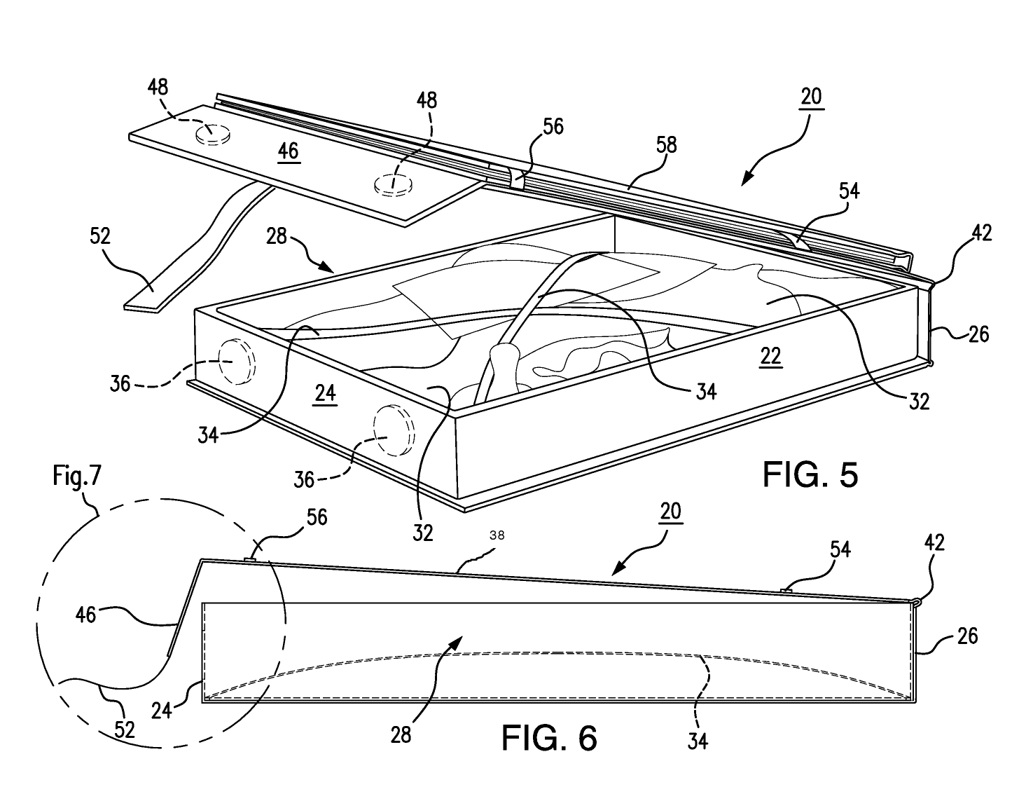

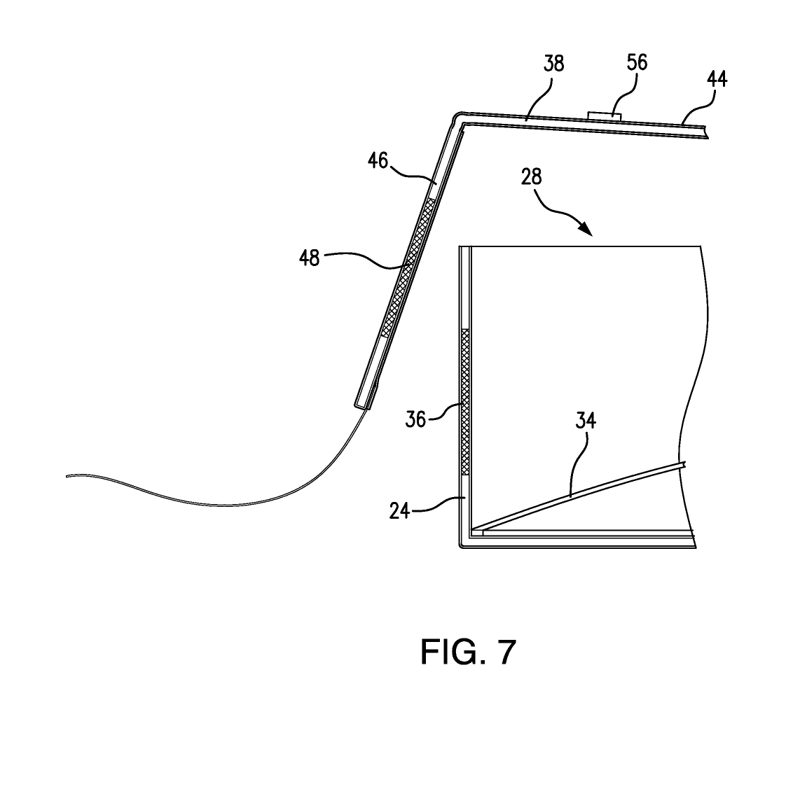

In one possible arrangement, the inner and outer straps (54 and 56) are both secured about the back cover 64 of book 58. In this arrangement, book 58 is secured to container 20, but a user is still free to open book 58 and peruse the individual pages 66. In another arrangement, the inner retaining strap 54 is secured over back cover 64 of book 58, but outer retaining strap 56 is secured over front cover 62 of book 58 (note FIG. 3). In this arrangement, book 58 and container 20 are releasably secured, but book 58 remains closed and the pages 66 are inaccessible.

An alternative embodiment of the present invention is disclosed in FIG. 4. In this embodiment, the flexible pages 66 are replaced by rigid pages 68. Additionally, pages 68 include a surface layer of a magnetic adhesive material 72. This allows photographs to be individually mounted and secured to a particular page 68. Additionally, a transparent film 74 can be included with each page for the purpose of protecting the photographs once mounted.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for organizing and displaying photos and mementos comprising in combination:
a container having opposing side walls and front and rear walls, the walls defining a storage area, a plurality of mementos positioned within the storage area, a pair of magnetic closures positioned within the front wall, a pair of crossed retaining straps secured within the storage area and serving to retain the plurality of mementos, a cover connected to the rear wall by way of a hinge, the cover having an external surface and a thickness, a closure flap pivotally secured to the cover at a location opposite the hinge, a pair of magnetic closures positioned within the closure flap, the closure flap adapted to be magnetically connected to the front wall via the magnetic closures to thereby retain the cover in a closed position over the storage area, a strap connected to the closure flap and functioning to assist in releasing the magnetic closures to thereby permit the cover to be pivoted to an opened position;
an inner and outer retaining strap secured to the cover of the container, each retaining strap having first and second extents, the first extent extending through the thickness of the cover and the second extent extending over the external surface of the cover, the inner retaining strap being secured proximate to the hinge and the outer retaining strap being secured proximate the closure flap;
a book with a series of pages, the book having hard bound front and back covers, the inner and outer retaining straps being selectively secured about the back cover of the book such that the book and container are releasably secured to one another but such that the pages of the book are accessible, the outer retaining strap being selectively secured over the front cover such that the book and container are releasably secured to one another but such that the pages of the book are inaccessible.

2. The system as described in claim 1 wherein the individual pages of the book are rigid, an adhesive magnetic material applied to each of the pages and functioning to secure individual pictures upon the page, each page further including a transparent sheet for covering the photos once secured.

3. A system for organizing and displaying photos and mementos comprising in combination:
a container having opposing side walls and front and rear walls, the walls defining a storage area, a cover connected to the rear wall by way of a hinge, a closure flap pivotally secured to the cover at a location opposite the hinge, an inner and outer retaining strap secured to the cover of the container, the inner retaining strap being secured proximate to the hinge and the outer retaining strap being secured proximate the closure flap;
a book with a series of pages, the book having front and back covers, the inner and outer retaining straps being selectively secured about the back cover of the book.

4. The system as described in claim 3 wherein the book can be selectively secured to the container in a first and second orientation, in the first orientation the inner and outer retaining straps are secured about the back cover of the book such that the pages of the book are accessible, in the second orientation the inner strap is secured about the back cover of the book but the outer retaining strap is secured over the front cover such that that the pages of the book are inaccessible.

5. The system as described in claim 3 further comprising a plurality of mementos positioned within the storage area and a pair of crossed retaining straps secured within the storage area and serving to retain the plurality of mementos,

6. The system as described in claim 3 further comprising a pair of magnetic closures positioned within the front wall and a pair of magnetic closures positioned within the closure flap, the closure flap adapted to be magnetically connected to the front wall via the magnetic closures to thereby retain the cover in a closed position over the storage area.

7. The system as described in claim 3 further comprising a strap connected to the closure flap and functioning to assist in releasing the magnetic closures to thereby permit the cover to be pivoted to an opened position.

8. The system as described in claim 3, wherein each retaining strap has first and second extents and the cover includes first and second apertures, the first extent of the inner strap extending through the first aperture and the first extent of the outer strap extending through the second aperture.
